(19) United States
(12) Patent Application Publication
(10) Pub. No.: US 2004/0264845 A1
(43) Pub. Date: Dec. 30, 2004

(54) Digital optical switch

(76) Inventor: Ruolin Li, Santa Clara, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/465,199

(22) Filed: Jun. 19, 2003

(51) Int. Cl. G02B 6/26; G02B 6/42

(52) U.S. Cl. 385/18

(57) ABSTRACT

A digital optical switch may have two states. Light incident on the switch may be selectively switched from a first path to a second or third path. Each of the paths may be formed in a planar light circuit as waveguides in one embodiment of the present invention. In one state, the switch may have an index or refraction that matches the index of the first waveguide. In another state, the index of refraction may be lower than that of the first waveguide. As a result, the incident light may be selectively switched to a selectable one of the second and third paths. In one case, the light may be transmitted through the switch and in the other case it may be reflected by total internal reflection to a different path. In one embodiment, the index or refraction of the switch may be controlled by an electrical resistance heater.

### BACKGROUND

This invention relates generally to optical communication networks.

An optical communication network's optical signals may be transmitted from an origination point to a destination point. For example, a number of different optical signals, each of a different wavelength, may be multiplexed for transmission over a single optical path. In the course of transmitting these signals, it is desirable to switch signals from one path to another. For example, a signal of a given wavelength may be switched to another path to an intended destination.

Optical switches may be implemented in planar light circuits using Mach-Zehnder interferometers. The Mach-Zehnder interferometer may include two spaced arms, at least one of which may be tuned using a heater. A Mach-Zehnder interferometer may be tuned by changing the refractive index of one of the two arms of the Mach-Zehnder interferometer. Generally a Mach-Zehnder interferometer includes a pair of gratings and a pair of couplers such that each grating is in a separate arm and the couplers couple the two arms. Input lights that are Bragg matched to the gratings propagate backwardly along the Mach-Zehnder arms and interfere with one another in a first coupler. Once the optical paths of both reflective lights are balanced, all lights over the wavelength span of interest are phase matched and all optical energy is transferred into the cross path of the first coupler with little energy returning back to the bar path.

Thus, the cross path of the first coupler becomes a drop wavelength port at which signals at the Bragg wavelength of the Bragg gratings get filtered out from other channels. The signals at wavelengths other than the Bragg wavelength transmit through the Bragg gratings and merge in the second coupler.

Although good optical performance can be achieved with these switches, Mach-Zehnder interferometers generally take up a large amount of space and consume power.

Thus, there is a need for better ways to provide optical switches in optical communication networks.

### BRIEF DESCRIPTION OF THE DRAWINGS

FIG. 1 is a cross-sectional view of one embodiment of the present invention taken generally along the line 1-1 in FIG. 2; and

FIG. 2 is a cross-sectional view taken generally along the line 2-2 in FIG. 1.

### DETAILED DESCRIPTION

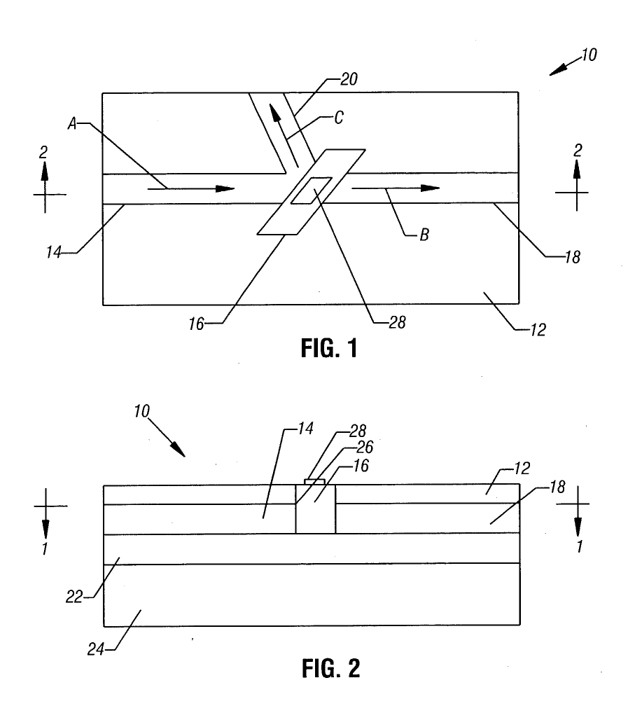

Referring to FIG. 1, an optical switch 10 may be placed in an optical network, such as a wavelength division multiplexed (WDM) network. An input optical signal, indicated at A, may travel along an input waveguide 14 formed in a planar light circuit 12. The waveguide 14 may include a clad optical core formed by semiconductor fabrication techniques in one embodiment. A planar light circuit is an optical device that may be made using conventional semiconductor fabrication techniques. The light signal A travels along the waveguide 14 until it comes to an interface defined by the material 16.

The material 16 can selectively transmit the light signal so that the signal A continues, as the signal B, along the waveguide 18. Alternatively, the material 16 may reflect the light signal A to become the light signal C traveling along the waveguide 20. The state of the material 16 may be controlled by an electrical resistance heater 28, which may be coupled to a source of current. In one state the material reflects a particular wavelength and in another state the same wavelength may be transmitted. The two states are distinguished by distinct refractive indices.

The material 16 may be a polymer whose refractive index may be changed by temperature. The size of the well containing the material may be relatively small, for example between 20 microns and 100 microns long. According to Snell's law, light incident onto a surface of two media of different refractive indices undergoes reflection and refraction. If the light is incident from a high refractive index to a low refractive index media, a phenomena called total internal reflection occurs. With total internal reflection, the incident angle is beyond a certain angle called the critical angle, regardless of polarization, so that no light is able to enter the low refractive index medium.

The light signal A, transmitted through the waveguide 14, passes through the material 16 to be coupled to the waveguide 18 when the refractive index of the material 16 matches that of the waveguide 14. This may occur with negligible insertion loss or return loss since the light is still well collimated, in some embodiments.

When the refractive index of the material 16 is reduced to below the refractive index of the waveguide 14, for example by increasing the temperature of the material 16, total internal reflection (TIR) may occur. Since the material 16 may exhibit negative index change with temperature in one embodiment, heating the material 16 can trigger the onset of total internal reflection. The material 16 may be controllably heated by the local heater 28.

After total internal reflection, light will be coupled to the waveguide 20 which is mirror symmetric to the waveguide 14 with respect to the material 16 waveguide 14 interface. The angle of incidence may be predetermined to be larger than the critical angle.

As a result, the light signal A, from the waveguide 14, can be selectively coupled to the waveguide 18 or the waveguide 20 in a controlled manner, in one embodiment, by thermally changing the index of refraction of the material 16. The thermal tuning of the material 16's refractive index can be implemented by introducing a local heater 28 within or without the well containing the material 16 in one embodiment. If the well is relatively small, the power consumption of the heater 28 may be negligible. As only the two refractive index values are needed to direct the coupling and to realize the switching function, the switch may operate in a digital manner in one embodiment.

Thus, referring to FIG. 2, a substrate 24 may include an upper cladding 12, a lower cladding 22, and an incident waveguide 14. For example, the waveguide 14 may be formed of silica on silicon, with a refractive index of 1.45. The material 16 may be contained within a well 26 formed in the planar light circuit 12. The well 26 may be formed by patterned etching techniques in one embodiment. A heater 28 may be deposited on top of the material 16 and coupled to a controllable electrical potential.

Thus, the material 16 stands between the waveguide 14 and the waveguide 18. Because of the angulation of the material 16 with respect to the waveguide 14, when total internal reflection occurs, the light signal A is redirected or reflected to become the light signal C along the waveguide 20.

In the off or natural state, the material 16 has the same refractive index as the waveguide 14. In the on state, the index of the material 16 is changed by heating to a value that causes total internal reflection to occur at the waveguide 14 to material 16 interface at the input side. As a result, light is reflected to the waveguide 20. Thus, a 1×2 switch may result that has low power consumption and small size in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An optical switch comprising:
a first light path;
a material formed in optical communication with said first light path, said material having at least two selectable refractive index states;
a device to selectively alter the state of the material; and
a second and third optical path arranged to convey light from said first path.

2. The switch of claim 1 wherein said material has an index refraction in a first state that matches the index of refraction of the first waveguide and an index or refraction in a second state which is less than the index or refraction of the first waveguide.

3. The switch of claim 1 wherein said paths are waveguides.

4. The switch of claim 1 wherein said switch is a planar light circuit.

5. The switch of claim 1 wherein said device includes a resistance heater.

6. The switch of claim 5 wherein said heater is deposited on said material.

7. The switch of claim 4 wherein said material is in a trench in said planar light circuit.

8. The switch of claim 4 wherein said material is arranged at a non-perpendicular angle to said first path.

9. The switch of claim 1 wherein said paths abut said material.

10. The switch of claim 1 wherein said material is a polymer.

11. A method comprising:
conveying a light signal through a waveguide; and
controlling the index of refraction of a material in said light path to switch said light signal to one of at least two alternate light paths.

12. The method of claim 11 including forming said light path and said alternate light paths in a planar light circuit.

13. The method of claim 11 including switching between said alternate paths using a material whose index of refraction may be selectively altered.

14. The method of claim 13 including altering the index of refraction of said material by applying heat.

15. The method of claim 11 including selectively initiating total internal reflection in order to switch said light signal to said one of two alternate paths.

16. The method of claim 11 including applying heat to a material to switch said light signal to one of said two alternate paths.

17. The method of claim 11 including arranging a material at a non-perpendicular angle to said light path and selectively reflecting light from said light path to a second light path arranged at a non-perpendicular angle to said light path.

18. The method of claim 17 including selectively either transmitting or reflecting said light signal to cause said light signal to precede along one of said two alternative paths.

19. The method of claim 11 including causing the material along said first light path to match the index of refraction of said light path in one state and to have an index of refraction in its second state which is less than the index of refraction of said light path.

20. The method of claim 11 including forming an optical switch by forming three waveguides in a planar light circuit, forming a well in said planar light circuit, said well in abutment with said light path, and filling said well with a material whose index of refraction may be thermally altered.

21. A method comprising:
forming a well in a planar light circuit;
filling said well with a material whose index of refraction may be changed by heating; and
forming at least three waveguides in abutment with said well such that light extending along a first waveguide is selectively transferred to one of said second and third waveguides depending on the temperature of said material.

22. The method of claim 21 including filling said well with a material whose index of refraction may be changed from a first index that matches the first waveguide to an index of refraction of less than the index of refraction of said first waveguide.

23. The method of claim 21 including depositing a heater on said material.

24. The method of claim 21 including forming said well at a non-perpendicular angle to said first and second waveguides.

25. The method of claim 24 including arranging the third waveguide to receive light transmitted from said first waveguide through said material.

26. The method of claim 25 including arranging said first and second waveguides at an angle of approximately 45 degrees.
